(19) United States
(12) Patent Application Publication
(10) Pub. No.: US 2015/0278828 A1
(43) Pub. Date: Oct. 1, 2015

(54) MARKET ANALYSIS FOR AN ONLINE BUSINESS

(71) Applicant: Locu, Inc., San Francisco, CA (US)

(72) Inventors: Adam Marcus, Cambridge, MA (US); Keir Mierle, San Francisco, CA (US); Marek Olszewski, San Francisco, CA (US); Tina Nguyen, Cupertino, CA (US); Maksim Stepanenko, San Francisco, CA (US); Zhenya Gu, Cambridge, MA (US)

(73) Assignee: Locu, Inc., San Francisco, CA (US)

(21) Appl. No.: 14/227,992

(22) Filed: Mar. 27, 2014

(51) Int. Cl. G06Q 30/02

(52) U.S. Cl. CPC G06Q 30/0201

(57) ABSTRACT

A method for performing a market analysis for a first online business is disclosed. Market information for a plurality of online businesses may be collected. A user may request a market analysis for the first online business. Market information for the first online business may also be collected. The marketing information for the plurality of online businesses and the first online business may be canonicalized to make comparisons easier. One or more online businesses in the plurality of online businesses may be selected as being similar to the first online business. The marketing information for the first online business may be compared to the marketing information of the similar one or more online businesses. The results of the comparison may be displayed to the user. The user may request modifications to the first online business. The first online business may be modified and the modified online business may be published.

### FIELD OF THE INVENTION

The present invention generally relates to the field of designing websites and more particularly to performing a market analysis of a website by comparing the website with similar websites or content associated with similar websites.

### SUMMARY OF THE INVENTION

The present invention provides methods for providing a market analysis for a business, and preferably a first online business connected to a network, such as the Internet. The process may be performed using one or more hardware servers connected to the network. The hardware servers may collect marketing information for a plurality of online businesses connected to the network.

The marketing information for the plurality of online businesses may be collected using any currently known or developed in the future method, such as, as non-limiting examples, scraping or analyzing data (files, templates, metadata, etc.) from a plurality of websites associated with the plurality of online businesses. Each online business may have at least one associated website. The marketing information for the plurality of online businesses may be stored in a database.

The hardware server(s) may receive a request from a user for a marketing analysis of the first online business. The user may be the owner (or a representative for the owner) of the first online business. The marketing information for the first online business may have been included in the marketing information for the plurality of online businesses. The marketing information for the first online business is preferably removed, if it was there, from the data for the marketing information for the plurality of online businesses.

The marketing information for the first online business may also be collected using any currently known or developed in the future method, such as, as non-limiting examples, website scraping or analyzing website data (files, templates, metadata, etc.) from a website associated with the first online business.

In some embodiments, the marketing information for the plurality of online businesses and the marketing information for the first online business may be canonicalized so as to be in a standard or preferred format to make the marketing information from the plurality of online businesses and the first online business easier to compare.

The hardware server(s) may determine, from the plurality of online businesses, one or more online businesses that are similar to the first online business. The similarity may be in the genre/type and/or the location of the first online business, but may also include other factors such as the average price points of goods or services, current demographics, targeted demographics and/or the sizes (as determined by sales) of the businesses.

The hardware server(s) may compare the marketing information from the one or more online businesses that are similar to the first online business with the marketing information from the first online business. The marketing information comparison may include visibility information (such as website views or views of the first online business on third party websites such as Yelp and Google), traditionally desired marketing metrics (such as pricing) and website metrics (such as the presentation, e.g., location, quantity, size, color, etc. of the images, sound and/or text of the goods and/or services displayed on the website). In other embodiments, the first online business may also be compared to venues based on information extracted and structured through websites and other public sources.

The marketing information from the one or more online businesses that are similar to the first online business and marketing information for the first online business may be displayed by the hardware server(s) to the user. The marketing information for the first online business and the one or more similar online businesses may be displayed in any desired manner. For example, the marketing information for the one or more similar online businesses may be averaged or combined and then displayed as one or more statistics (e.g., minimum, maximum, 95th percentile, median counts), prices of products and/or service, bar graphs and/or pie charts. Further, only the most relevant and/or helpful marketing information is displayed to the user. The user may have a client computer with a display running a browser that is configured to be able to view the displayed marketing information from the first online business and the one or more similar online businesses.

In some embodiments, the hardware server(s) may recommend to the user one or more actions or modifications to the website associated with the first online business based on the comparison of the marketing information for the first online business and the marketing information for the one or more online businesses that are similar to the first online business.

The hardware server(s) may receive a request from the user to modify the website, either as earlier recommended or in some other manner. If the user requests a modification, the hardware server(s) may modify the website (such as by modifying the HTML code for the website) according to the request and then publish the modified website. In preferred embodiments, the hardware server(s) provide hosting services for the first online business and/or to the plurality of online businesses. Providing hosting services for the first online business and/or to the plurality of online businesses allows the hardware server(s) to analyze, modify and publish websites without the need of working through a third party that hosts the websites. However, in other less preferred embodiments, a third party hosting provider may be used to allow the hardware server(s) to analyze, modify and/or publish websites.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 is a flow diagram illustrating a first embodiment of a method for practicing the invention.

FIG. 3 is a flow diagram illustrating the first embodiment illustrated in FIG. 2, combined with the step of displaying the results to the user.

FIG. 4 is a flow diagram illustrating the first embodiment illustrated in FIG. 2, combined with the step of recommending an action to the user.

FIG. 5 is a flow diagram illustrating the first embodiment illustrated in FIG. 2, combined with the step of canonicaling the marketing information.

FIG. 6 is a flow diagram illustrating the first embodiment illustrated in FIG. 2, combined with the steps of receiving a request for a user to modify the website, modifying the website and then publishing the website.

FIG. 7 is a flow diagram illustrating the first embodiment illustrated in FIG. 2, but defines the collection of marketing information as scraping the marketing information from the first online business's websites and/or scraping the marketing information from the plurality of online businesses' websites.

FIG. 8 is a flow diagram illustrating the first embodiment illustrated in FIG. 2, but adds the disclosure of hosting the websites for one or more of the plurality of online businesses and/or hosting the website for the first online business.

FIG. 9 is a flow diagram illustrating an embodiment for transmitting marketing information over an API to a requester.

FIG. 10 is a flow diagram illustrating an embodiment for displaying marketing information on a map on a webpage to a requester that matches the requester's search criteria.

FIG. 11 is an example of a webpage that may be used in an embodiment of the invention.

FIG. 12. is an example of a webpage that may be used in an embodiment of the invention.

FIG. 13 is an example of a webpage that may be used in an embodiment of the invention.

FIG. 14 is an example of a webpage that may be used in an embodiment of the invention.

FIG. 15 is an example of a webpage that may be used in an embodiment of the invention.

FIG. 16 is an example of a webpage that may be used in an embodiment of the invention to graphically illustrate marketing information.

FIG. 17 is an example of a webpage that may be used in an embodiment of the invention to illustrate a list of similar businesses.

FIG. 18 is an example of a webpage that may be used in an embodiment of the invention that may be used to graphically represent data to compare similar businesses.

FIG. 19 is an example of a webpage that may be used in an embodiment of the invention that may be used to graphically illustrate with a bar graph marketing information.

FIG. 20 is an example of a webpage that may be used in an embodiment of the invention that may be used to graphically illustrate with bar graphs marketing information.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

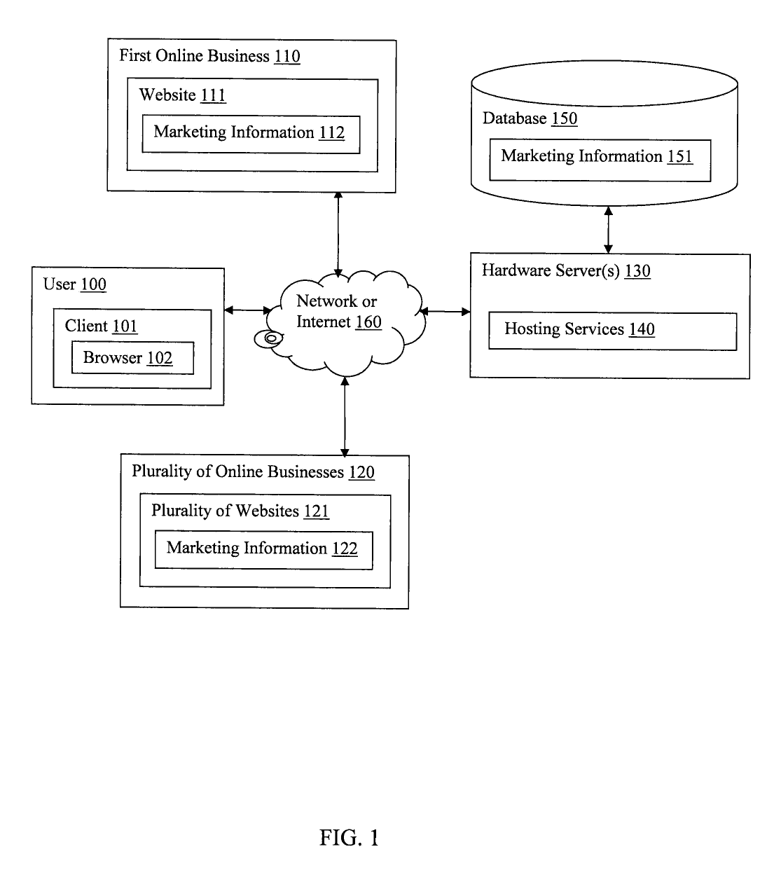

FIG. 1 is a block diagram of a system that may be used to practice the present invention. Network 160 is a collection of links and nodes (e.g., multiple computers and/or other devices connected together) arranged so that information may be passed from one part of the network 160 to another over multiple links and through various nodes. Examples of networks 160 include the Internet, the public switched telephone network, the global Telex network, computer networks (e.g., an intranet, an extranet, a local-area network, or a wide-area network), wired networks, wireless networks and/or combinations thereof. While the invention may be practiced with any network 160, the invention will generally be described as using the Internet 160 to provide a non-limiting example of how the invention may be practiced.

The Internet 160 is a worldwide network of computers and computer networks arranged to allow the easy and robust exchange of information between computer users 100 on clients 101 running browsers 102. Hundreds of millions of users 100 (people) around the world have access to computers (clients 101) connected to the Internet 160 via Internet Service Providers (ISPs). Content providers place multimedia information (e.g., text, graphics, audio, video, animation, and other forms of data) at specific locations on the Internet 160 referred to as websites 111, 121. In some websites 111, 121, the multimedia information may comprise marketing information 112, 122, particularly if the websites 111, 121 are part of an online business 110, 120. The combination of all the websites 111, 121 and their corresponding web pages on the Internet 160 is generally known as the World Wide Web (WWW) or simply the Web.

For Internet users 100 and online businesses 110, 120 alike, the Internet 160 continues to be increasingly valuable. Users 100 use the Internet 160 for everyday tasks, from social networking, shopping, banking, and paying bills to consuming media and entertainment. E-commerce is growing, with businesses 110, 120 delivering more services and content across the Internet 160, communicating and collaborating online, and inventing new ways to connect with each other. Each online business 110, 120 may have at least one website 111, 121 and many online businesses 110, 120 will also have a brick-and-mortar presence. As a specific, non-limiting example, the first online business 110 and the plurality of online businesses 120 may be for restaurants.

Prevalent on the Internet 160 are websites 111, 121 which offer and sell goods and services to individuals and organizations. Websites 111, 121 may consist of a single webpage, but typically consist of multiple interconnected and related webpages. Websites 111, 121, unless very large and complex or have unusual traffic demands, typically reside on a single hardware server 130 and are prepared and maintained by a single individual or entity (although websites 111, 121 residing on multiple hardware servers 130 are certainly possible). Menus, links, tabs, etc. may be used to move between different web pages within a website 111, 121 or to move to a different website 111, 121.

Websites 111, 121 may be created using HyperText Markup Language (HTML) to generate a standard set of tags that define how the webpages for the website 111, 121 are to be displayed. Users 100 of the Internet 160 may access online businesses' 110, 120 websites 111, 121 using software known as an Internet browser 102, such as MICROSOFT INTERNET EXPLORER, MOZILLA FIREFOX or GOOGLE CHROME. After the browser 102 has located the desired webpage, the browser 102 may request and receive information from the website 111, 121, typically in the form of an HTML document, and then display the website content for the user 100 on the client 101. The user 100 then may view other webpages at the same website 111, 121 or move to an entirely different website 111, 121 using the browser 102.

Some online businesses 110, 120, typically those that are larger and more sophisticated, may provide their own hardware, software, and connections to the Internet 160 to operate their own websites 111, 121. But many online businesses 110, 120 either do not have the resources available or do not want to create and maintain the infrastructure necessary to host their own websites 111, 121. To assist such online businesses 110, 120, hosting companies exist that offer website hosting services 140. These hosting providers typically provide the hardware, software, and electronic communication equipment necessary to connect multiple websites 111, 121 to the Internet 160. A single hosting service provider may literally host thousands of websites 111, 121 on one or more hardware servers 130. In preferred embodiments, the hosting services 140 operated by the hardware server(s) 130 provide hosting services for either, and preferably both, the website 111 for the first online business 110 and the plurality of websites 121 for the plurality of online businesses 120.

Browsers 102 are able to locate specific websites 111, 121 because each website 111, 121, resource, and computer on the Internet 160 has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC: BA98: 0332: 0000: CF8A: 000C: 2154: 7313).

IP addresses, however, even in human readable notation, are difficult for people to remember and use. A Uniform Resource Locator (URL) is much easier to remember and may be used to point to any computer, directory, or file on the Internet 160. A browser 102 is able to access a website 111, 121 on the Internet 160 through the use of a URL. The URL may include a Hypertext Transfer Protocol (HTTP) request combined with the website's 111, 121 Internet address, also known as the website's 111, 121 domain name. An example of a URL with a HTTP request and domain name is: http://www.companyname.com. In this example, the “http” identifies the URL as a HTTP request and the “companyname.com” is the domain name.

The user 100 will typically be an owner, the owner's agent, or another person associated with the first online business 110. The user 100 may use a client 101, such as, as non-limiting examples, a cell phone, PDA, tablet, laptop computer, or desktop computer to request that a market analysis be performed for a website 111. The client 101 may run a browser to allow the user 100 to easily navigate the Internet 160.

Websites 111, 121 may comprise one or more webpages. The websites 111, 121 may be hosted or operated by hardware server(s) 130 providing hosting services 140. The hardware server(s) 130 may be, as non-limiting examples, one or more Dell PowerEdge(s) rack server(s), HP Blade Server(s), or IBM Rack or Tower server(s), although other types or combination of servers may also be used. The hardware server(s) 130 may provide the electronic hardware to run computer programs that may be written to perform various functions and processes.

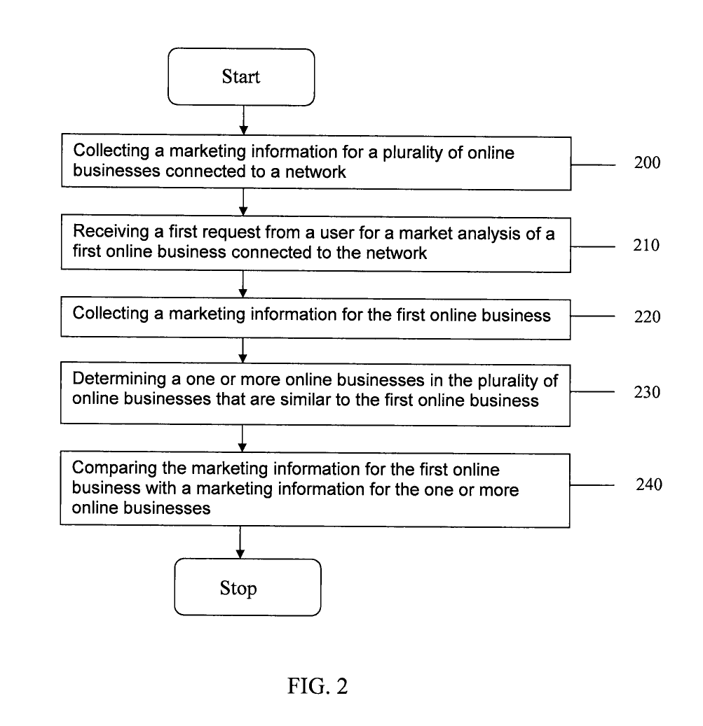

An exemplary process for practicing the invention is illustrated in FIG. 2. The present invention provides methods for providing a market analysis for a first online business 110 connected to a network, such as the Internet 160. For purposes of this specification and claims, a market analysis comprises information regarding a plurality of online businesses 120 (typically competitors' online businesses 120) and suggestions for a first online business 110 (typically the user's 100 online business 110).

The hardware server(s) 130 may collect marketing information 122 for a plurality of online businesses 120 connected to the Internet 160. (Step 200) For purposes of this specification and claims, marketing information 122, 112 is defined as any data that affects a website's ability to sell or advertise goods and/or services. As a non-limiting example, online businesses associated with restaurants may collect marketing information 122, 112 from the online websites' menus.

The marketing information 122 for the plurality of online businesses 120 may be collected using any currently known or developed in the future method, such as, as non-limiting examples, scraping and/or analyzing data from a plurality of websites 121 associated with the plurality of online businesses 120.

Scraping is a technique for collecting data (which may include marketing information 122) from a plurality of online businesses 120, each having a website 121. A computer program may scrape the plurality of online businesses 120 by simulating the actions of a user 100 to receive data from the plurality of online businesses 120 over the Internet 160. The computer program may, as non-limiting examples, use Hypertext Transfer Protocol (HTTP) or a browser to collect the data from the plurality of online businesses 120. The data may be analyzed to identify the marketing information 122 for each of the plurality of online businesses 120.

The hardware server(s) 130 may also directly analyze data (files, HTML code, templates, metadata for the websites and/or customer data) associated with one or more of the plurality of online businesses 120. If the hardware server(s) 130 are providing hosting services 140 for one or more of the plurality of online businesses 120, the hardware server(s) 130 may be able to access the data directly. Otherwise, the hardware server(s) 130 may collect the data through one or more other hosting providers via cooperative agreements with the hosting providers and customers (owners of online businesses). The data may be analyzed to identify the marketing information 122 for the plurality of online businesses 120.

The marketing information 151 for the plurality of online businesses 120 may be stored as data in a database 150. A database 150 is an organized collection of data. The data may be organized to model relevant aspects of reality in a way that supports processes requiring this information. Database management systems (DBMSs) are specially designed applications that interact with hardware server(s) 130, other applications, and the database itself to capture and analyze data. A general-purpose database management system (DBMS) is a software system designed to allow the definition, creation, querying, update, and administration of databases. As non-limiting examples, DBMSs may include MySQL, MariaDB, PostgreSQL, SQLite, Microsoft SQL Server, Oracle, SAP, dBASE, FoxPro, IBM DB2, LibreOffice Base, FileMaker Pro, Cassandra and Redis.

The hardware server(s) 130 may receive a request from a user 100 for a marketing analysis of a first online business 110. (Step 210) The user 100 will typically be, but does not have to be, the owner (or a representative for the owner) of the first online business 110. The marketing information 112 for the first online business 110 may or may not be part of the marketing information 122 for the plurality of online businesses 120. Preferably, the marketing information 112 for the first online business 110 is removed, if it was there, from the data for the marketing information 122 for the plurality of online businesses 120.

In another embodiment, the marketing analysis may be performed on a first business that may or may not be online, i.e. have a website 111. As an example, data (such as a picture) may be taken directly from a hardcopy of the first business's menu. The data in the picture may be structured and then compared to the marketing information 122 from one or more online businesses that are similar to the first business.

The marketing information 112 for the first online business 110 may also be collected using any currently known or developed in the future method, such as, as non-limiting examples, scraping or analyzing data from a website 111 associated with the first online business 110. (Step 220) Content generated by the plurality of online businesses 120 and by the first online business 110 may also be reviewed, either programmatically or manually for marketing information 122, 151. Optionally, the first online business 110 and/or the plurality of online businesses 120 may be called on a telephone and asked questions to gain additional marketing information 122, 151.

The hardware server(s) 130 may determine, from the plurality of online businesses, one or more online businesses that are similar to the first online business. (Step 230) The similarity is preferably in the genre and/or the location of the first online business 110, but may also include factors such as the average price points of goods or services, current demographics, targeted demographics and/or the sizes of the businesses. Other methods for determining similar online businesses may include searching for similar text in the offerings (e.g., “slice”/“pizza”) in two different menus, genres or names, finding a significant overlap in customers and the distance between businesses. In some embodiments, the user 100 may request to be compared to a particularly successful or trendy (even if not similar) business, group of businesses or locations that are known, for example, to set trends or be market leaders.

The hardware server(s) 130 may compare the marketing information from the one or more online businesses that are similar to the first online business 110 with the marketing information 112 from the first online business 110. (Step 240) The marketing information comparison may include traditional marketing metrics, such as pricing, but also may include website metrics, such as the presentation and advertisements (location, quantity, size, color, etc. of the images, sound and/or text) of the goods and/or services displayed on the website. The marketing information from the one or more online businesses that are similar to the first online business 110 may be combined, averaged, statistically analyzed, sorted, standardized or arranged in any manner (such as on maps, charts or graphs) to make it easier for the user 100 to compare the marketing information 112 for the first online business 110 with the marketing information from the one or more online businesses that are similar to the first online business 110. Other embodiments allow not just the website 111 to be compared, but the first online business's 110 web presence. The first online business's 110 web presence may include profiles on other websites, business directories, social networks, etc., for example on Yelp. The hardware servers 130 may report on traffic to these sites verses the first online business's website 111. The hardware servers 130 may also compare wording generated by the first online business 110 with wording generated by other online businesses 120, with or without canonicalization.

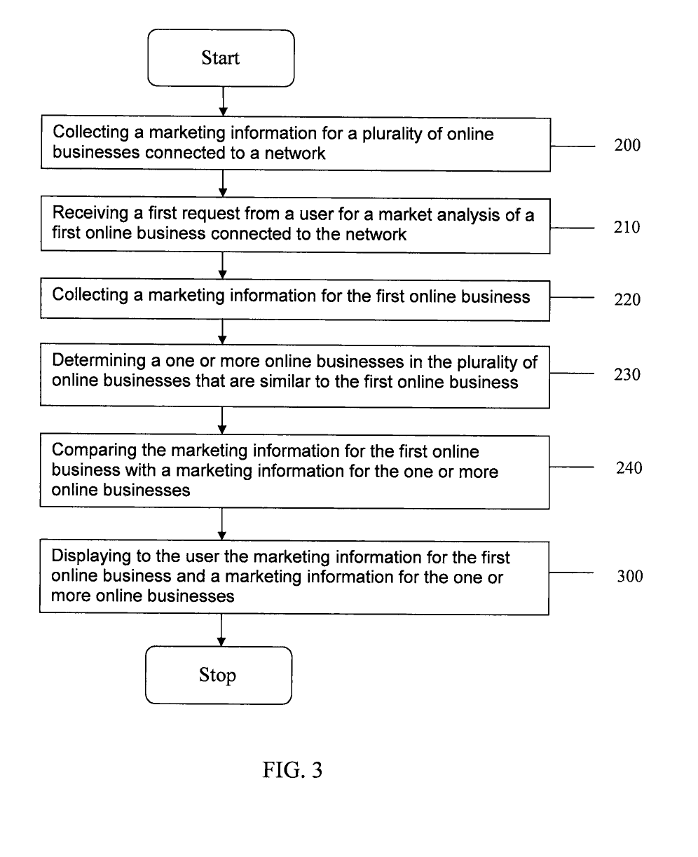

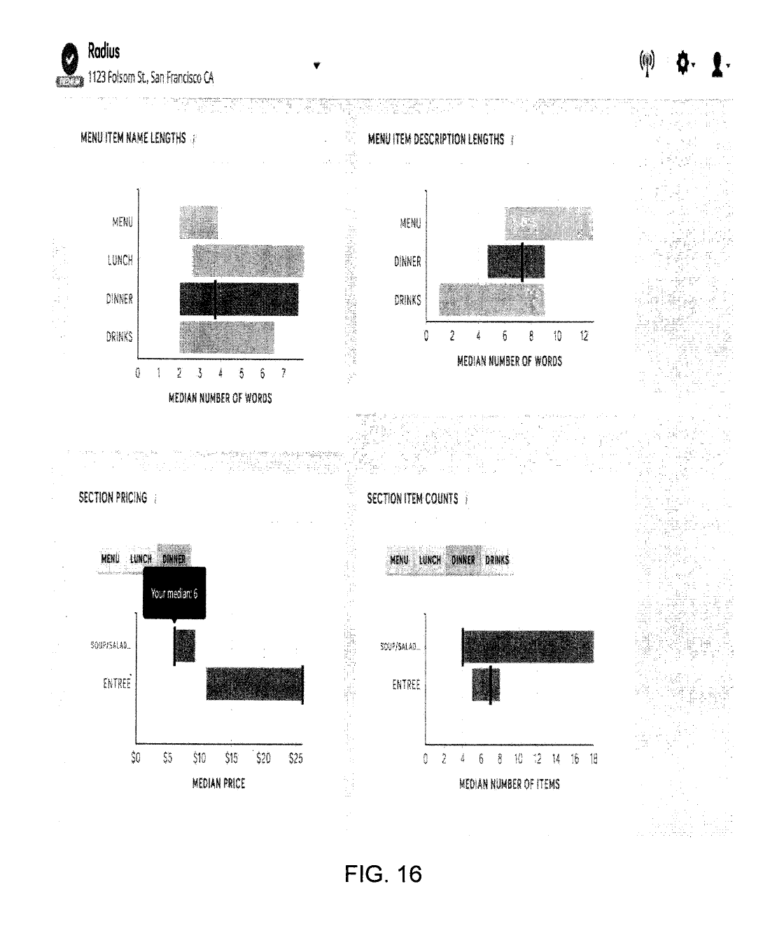

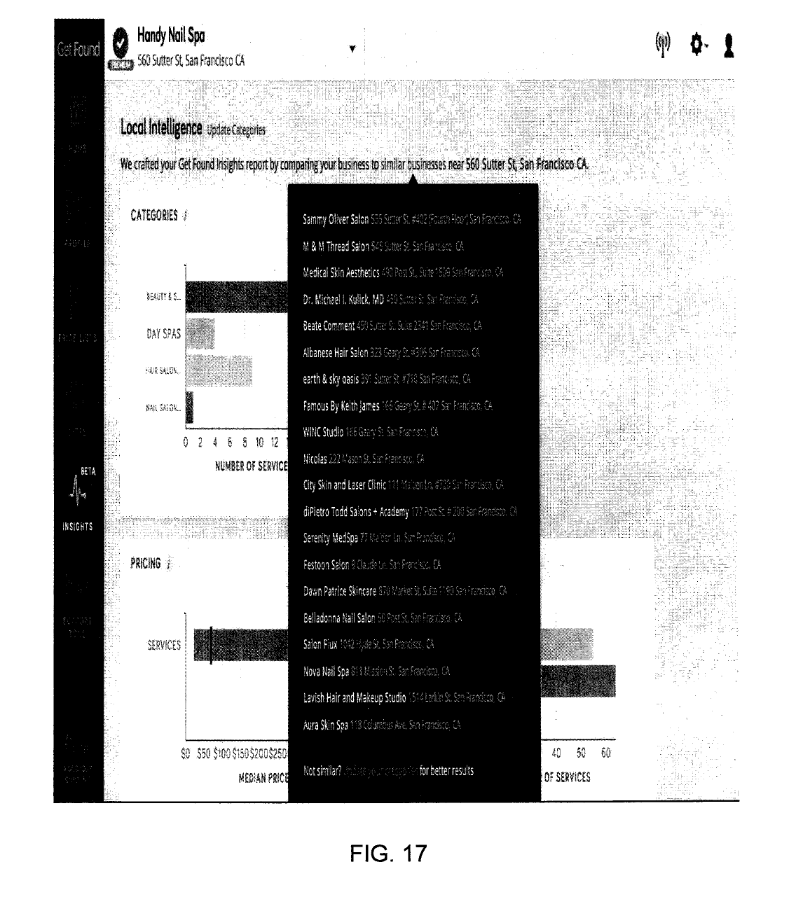

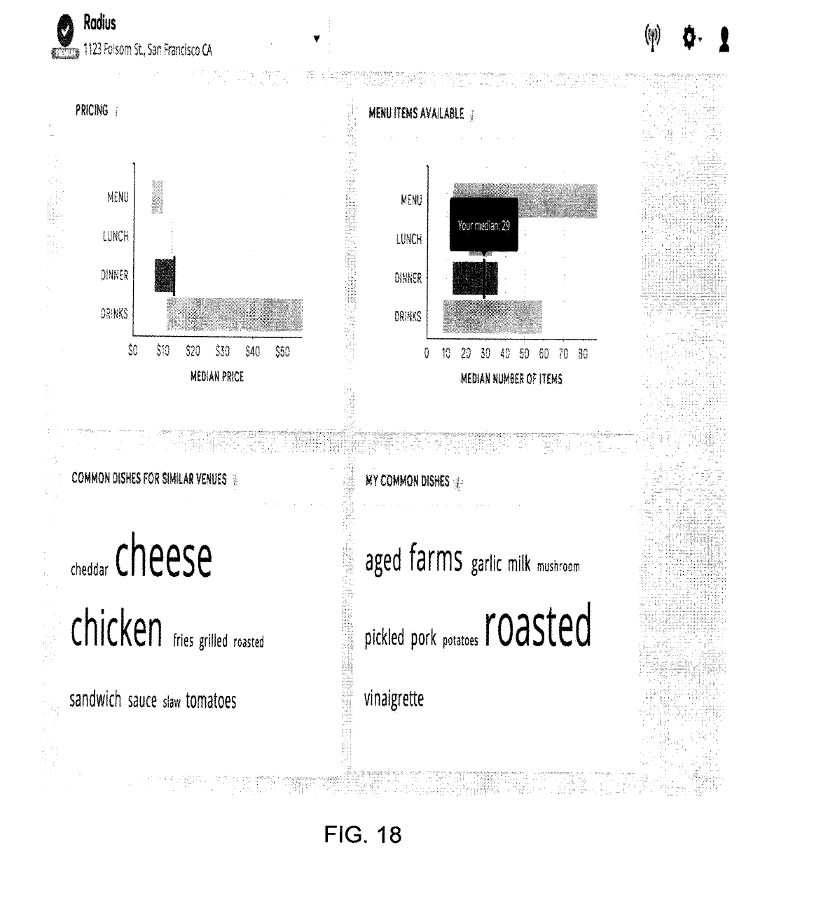

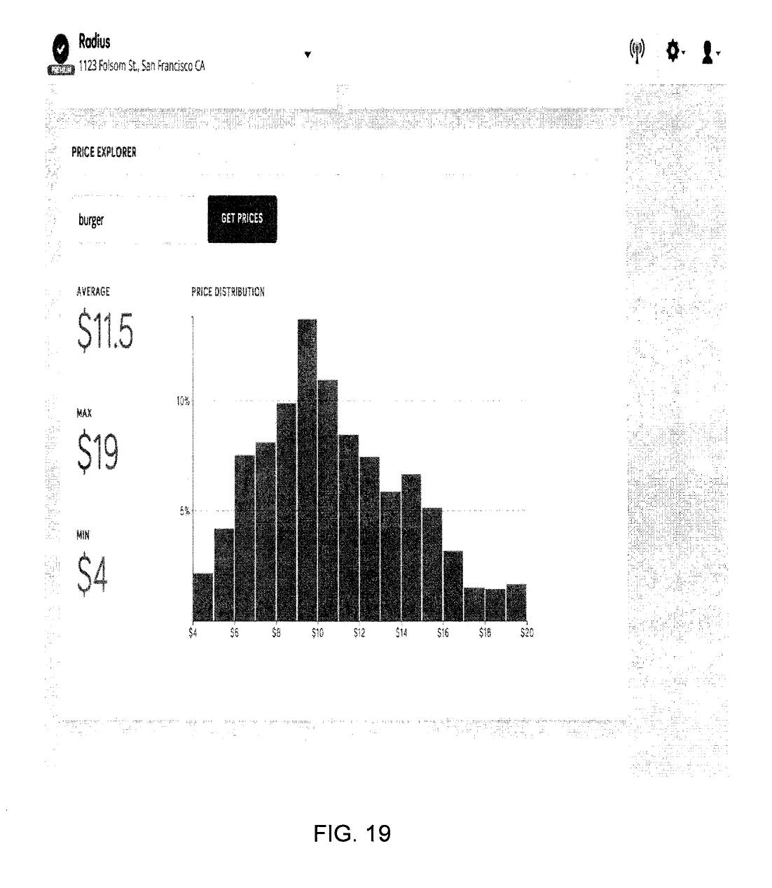

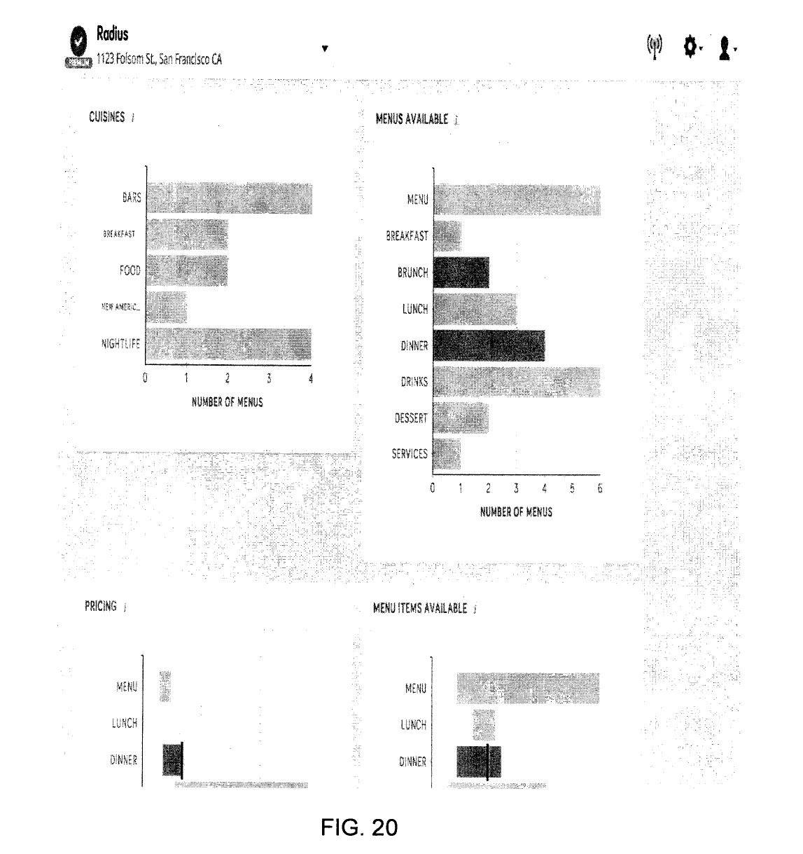

Another embodiment is illustrated in FIG. 3. This embodiment is similar to that illustrated in FIG. 2, but further includes the step of displaying to the user 100 the marketing information from the one or more online businesses that are similar to the first online business 110 and the marketing information for the first online business 110. (Step 300) The marketing information 112, 122 for either source may be displayed in any desired manner. For example, the marketing information 112, 122 may be averaged, totaled, standardized, and/or displayed in graphical representations, such as bar graphs or pie charts. As non-limiting examples, FIGS. 16-20 illustrate sample webpages that may be used to graphically display marketing information 112, 122 to the user 100. Further, only the most relevant and/or helpful marketing information is preferably displayed to the user 100. In addition, actionable sentences, e.g., “Your services list is too long—consider reducing the number of offerings to 7, which is the largest of all of your competitors” may be displayed to the user 100. The user 100 may have a client 101, with a display, running a browser 102 that is configured to be able to view the displayed marketing information.

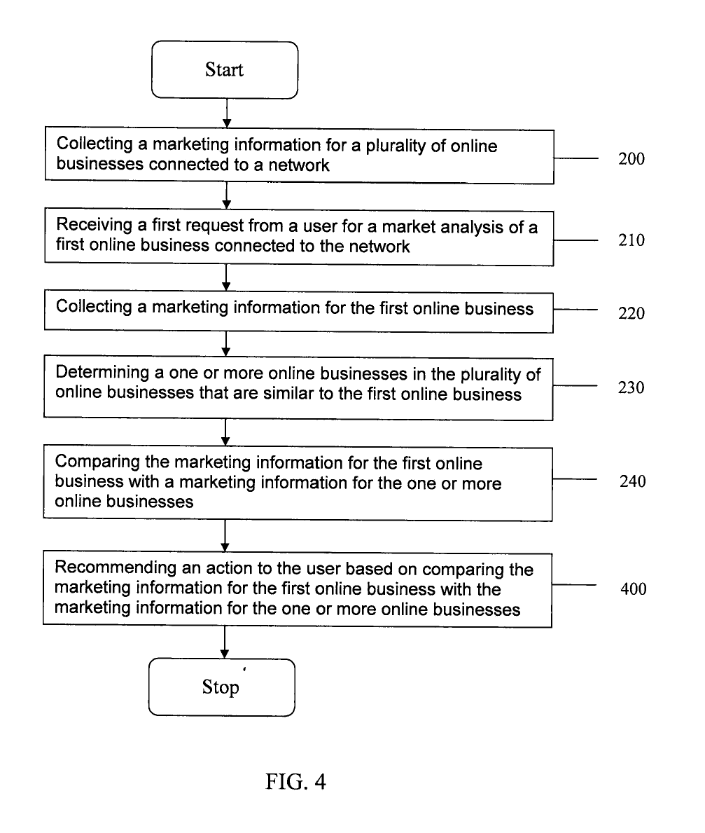

Another embodiment is illustrated in FIG. 4. This embodiment is similar to that illustrated in FIG. 2, but further includes the step of recommending to the user 100 one or more actions or modifications to the website 111 associated with the first online business 110 based on the comparison of the marketing information 112 for the first online business 110 and the marketing information for the one or more online businesses that are similar to the first online business. (Step 400)

As non-limiting examples, the hardware server(s) 130 may recommend to the user 100 to advertise on third parties, such as Google ads/offers and/or correct business listing information, such as phone numbers or addresses, in one or more business directories or social networks (for example Yelp or Facebook). If the user 100 has a restaurant, the hardware server(s) 130 may recommend to the user 100 to alter the price for one or more menu items, increase or decrease the length of one or more description in the menu and/or add or delete one or more entrees based on a comparison with the one or more similar online businesses that are also restaurants. Preferably actions that make the biggest difference are listed before or instead of actions that would make a lesser impact on the first online business 110. Based on pricing information, suggestions may be made to the user 100 to change the number of menu items in a menu/selection, price or description, based on a statistical analysis of the competition as well as best practices in human cognition or other factors.

In preferred embodiments, the hardware server(s) may quantify how much the actions, such as corrections to business directories, social networks and/or modifications to the website 111, will help consumers find their business 110. The quantification may be based on actions performed by past users for similar businesses and how much improvement these past similar businesses experienced.

In another embodiment, the user 100 may select one or more search criteria (such as a type of business and/or geographical area) so that the system may determine one or more similar businesses in a geographical area. A map may be displayed on a website to the user 100 showing the locations of the one or more similar businesses. In some embodiments, complimentary businesses may also be shown on the map. This embodiment may recommend an action to assists the user 100 in selecting a location to open a business where no or few similar businesses exist and/or where complimentary businesses exist.

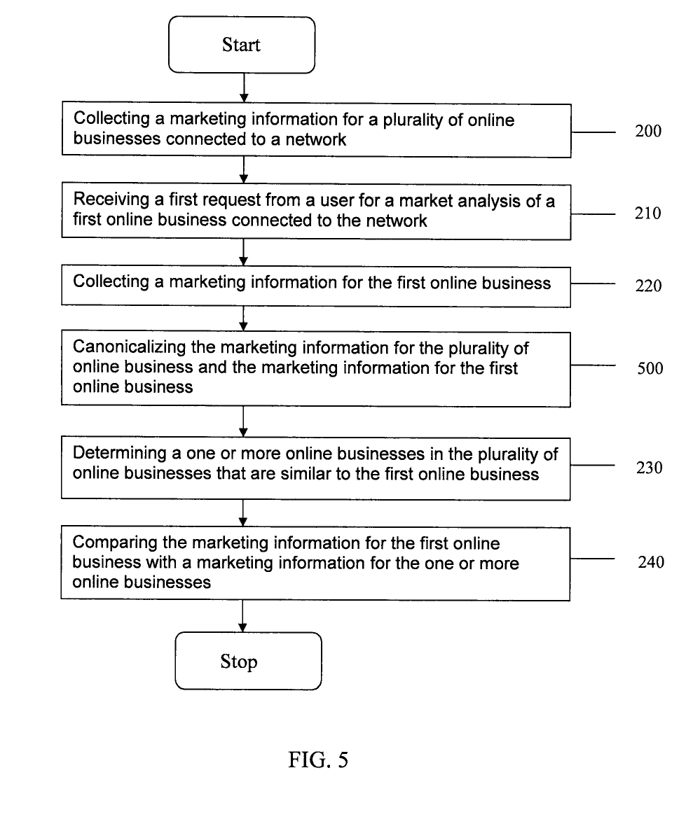

Another embodiment is illustrated in FIG. 5. This embodiment is similar to that illustrated in FIG. 2, but further includes the step of canonicalizing the marketing information 122 for the plurality of online businesses 120 and the marketing information 112 for the first online business 110. (Step 500) This step modifies the marketing information 112, 122 to place the data in a standard or preferred format to make the marketing information 112, 122 easier to compare. The canonicalizing process may also include removing meaningless words like “the”, adding synonyms, adding expansion terms (e.g., “merlot” may trigger adding “wine” and “alcohol”) and/or adding section/menu information (e.g., “Polenta cakes” in the small plates section of a dinner menu could turn into “Polenta cakes small plates dinner”)

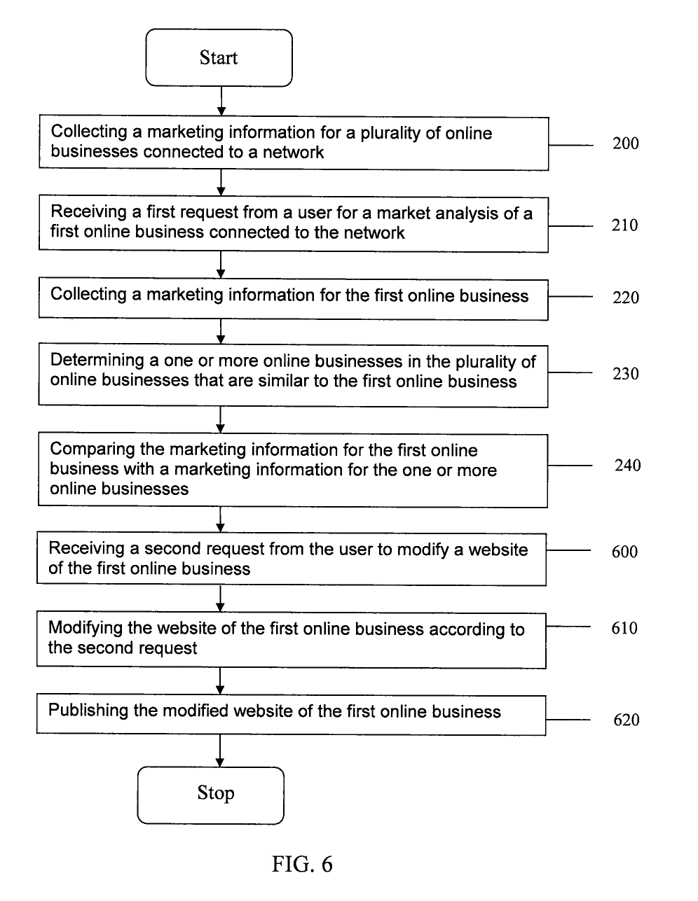

Another embodiment is illustrated in FIG. 6. This embodiment is similar to that illustrated in FIG. 2, but further includes the following steps. The hardware server(s) 130 may receive a request from the user 100 to modify the website 111, either as earlier recommended (as described for FIG. 4, Step 400) or in some other manner. (Step 600) If the user 100 requests a modification, the hardware server(s) 130 may modify the website (such as by modifying the HTML code for the website) according to the request of the user (Step 610) and then publish the website 111 (Step 620).

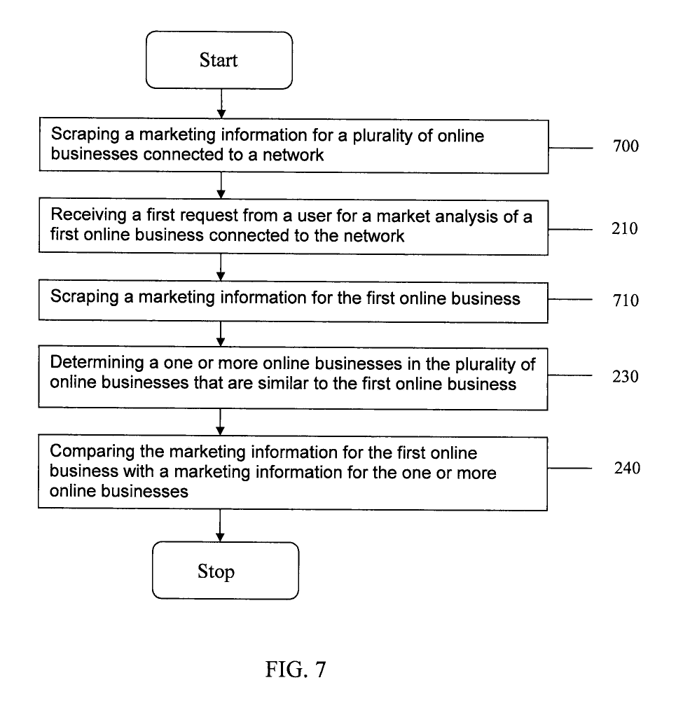

Another embodiment is illustrated in FIG. 7. This embodiment is similar to that illustrated in FIG. 2, but specifically states that the method of collecting marketing information 122 from the plurality of online business 120 (Step 700) and/or the marketing information 112 from the first online business 110 (Step 710) uses the scraping technique previously described. The scraping technique for collecting marketing information 112, 122 may be used on the first online business 110, the plurality of online businesses 120, neither or both.

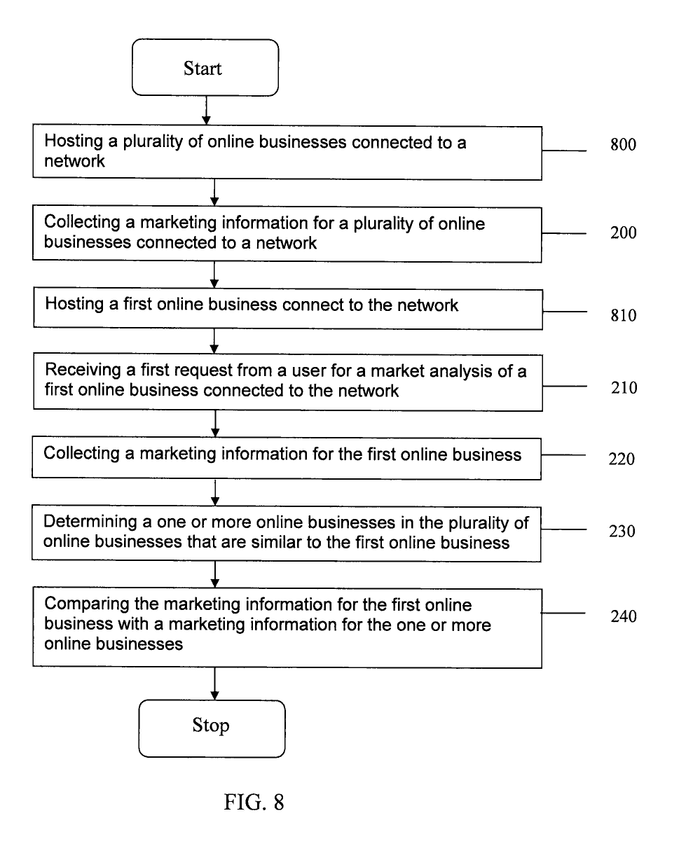

Another embodiment is illustrated in FIG. 8. This embodiment is similar to that illustrated in FIG. 2, but includes the hardware server(s) 130 providing hosting services 140 for the first online business 110 (Step 810) and/or to one or more of the plurality of online businesses 120 (Step 800). Providing hosting services 140 for the first online business 110 and/or to one or more of the plurality of online businesses 120 allows the hardware server(s) 130 to analyze, modify and publish websites without the need of working through a third party that hosts the website 111. However, in other less preferred embodiments, a third party hosting provider may be used to allow the hardware server(s) 130 to analyze, modify and/or publish the website 111.

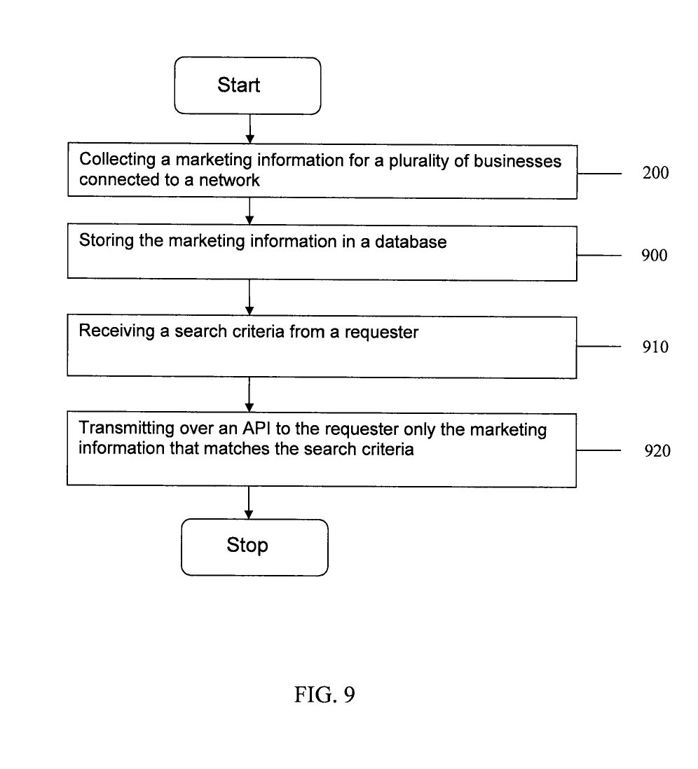

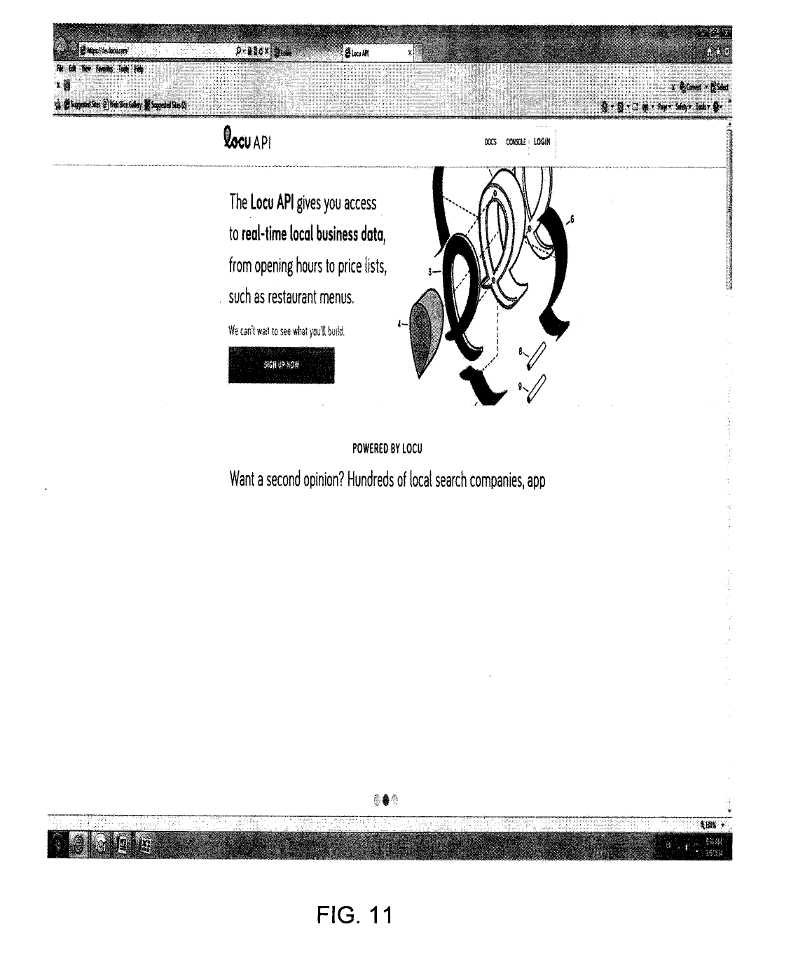

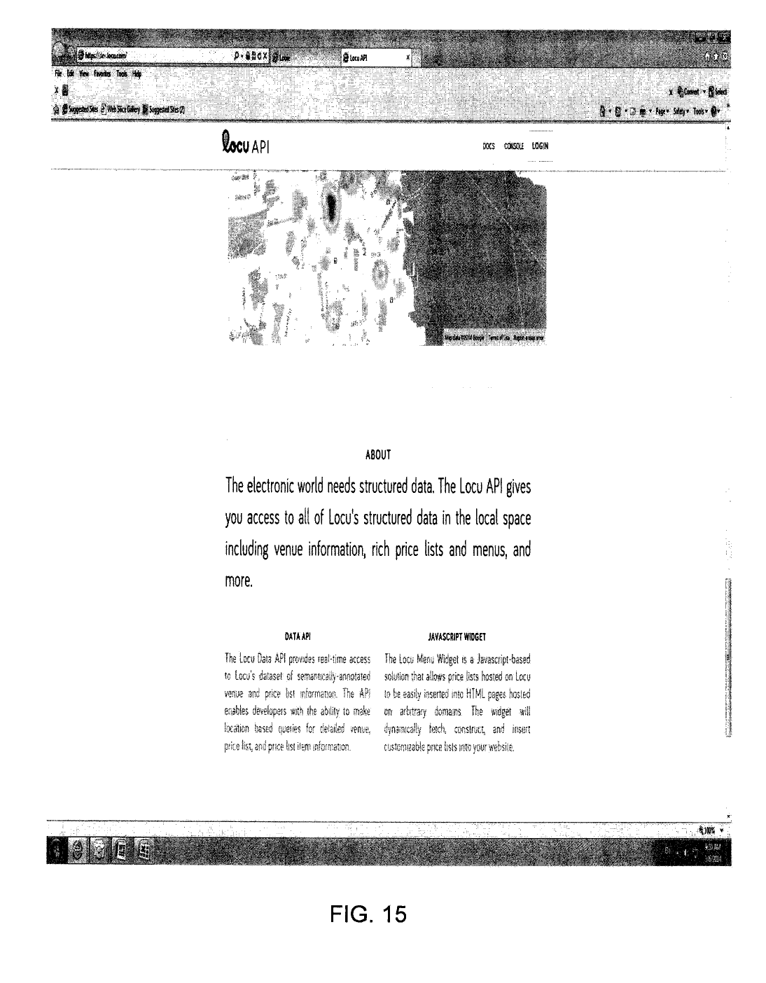

Another embodiment is illustrated in FIGS. 9 and 11-15. In this embodiment, marketing information 122 may be collected from a plurality of online businesses 120 as previously discussed. The marketing information 122 may be real-time local business data. (Step 200) The collected marketing information 122 is preferably stored in a database 150. (Step 900) One or more hardware servers 130 may receive a search criteria from a requester, preferably via an API. As non-limiting examples, the search criteria may identify a type of restaurant and a geographical region. The one or more hardware servers 130 may search the database 150 for marketing information 151 that matches the search criteria. The one or more hardware servers 130 may transmit, preferably over an API, to the requester only the marketing information 151 that matches the search criteria. (Step 920)

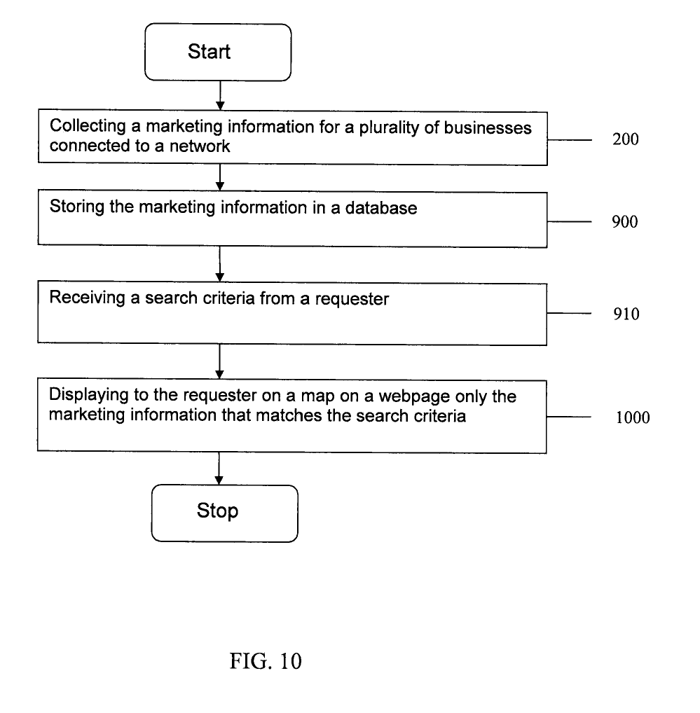

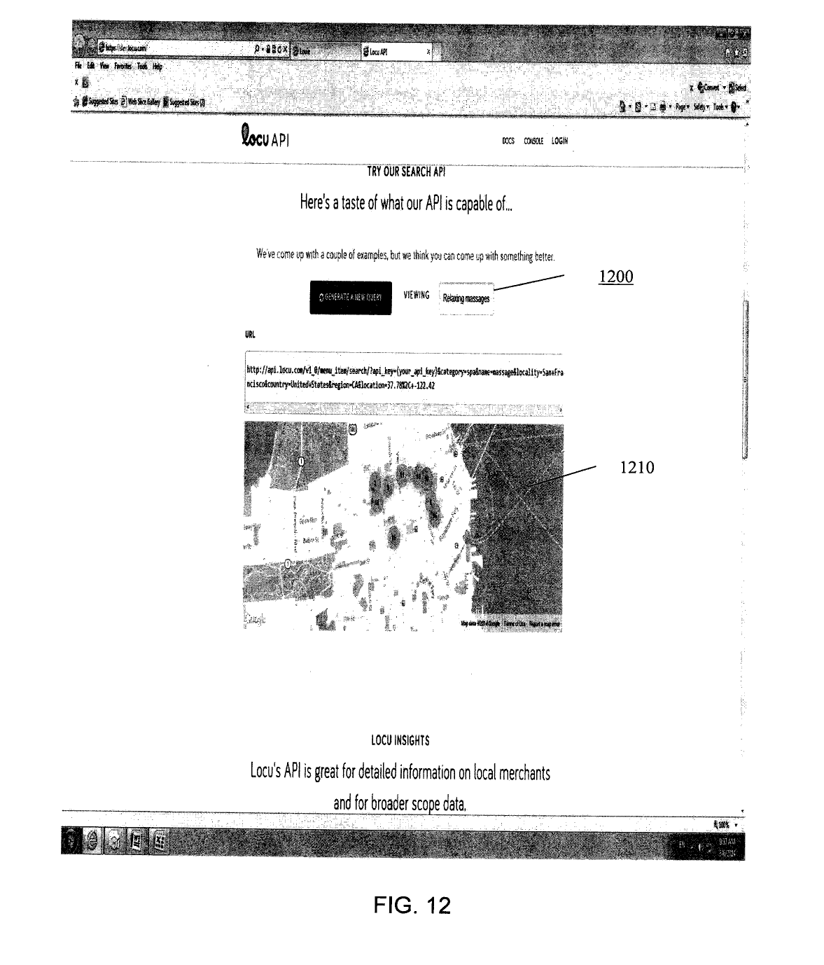

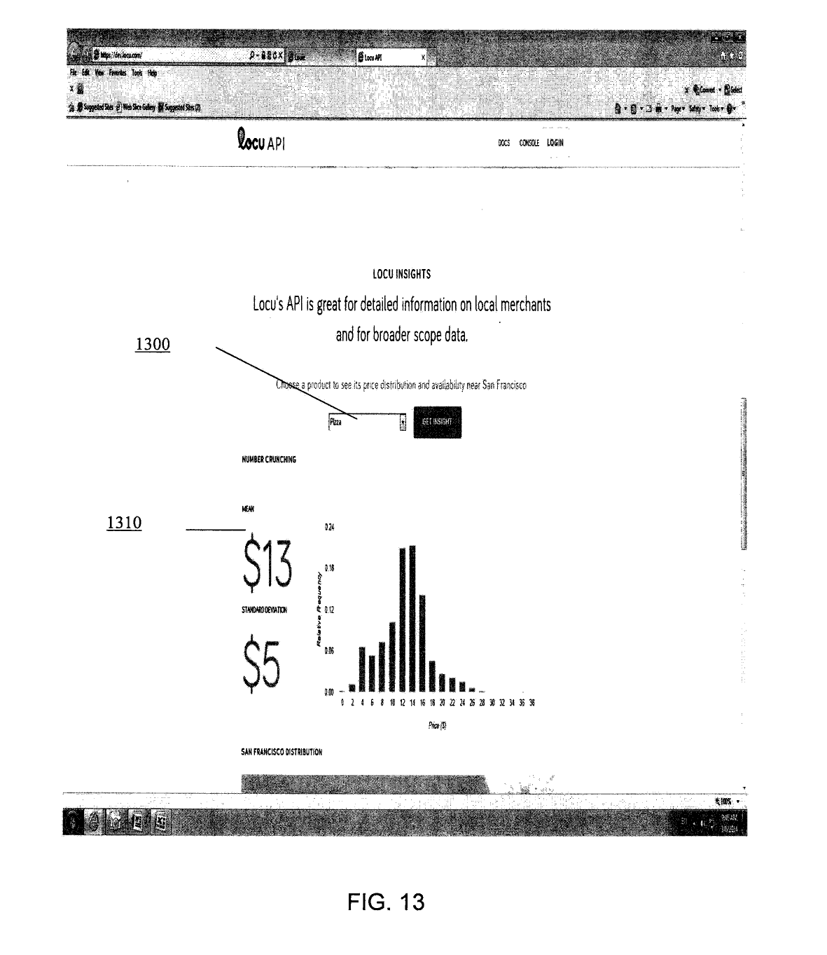

Another embodiment is illustrated in FIGS. 10 and 11-15. In this embodiment, the marketing information 122 may be collected (Step 200) and stored (900) as previously described. The user 100 (requester) may type the search criteria into an input field on a webpage designed for this purpose or select a search criteria from a provided menu 1200, 1300 as shown in FIGS. 12 and 13. (Step 910) The one or more hardware servers 130 may display to the user 100 (requester) on a map 1210, 1400 on a webpage only the marketing information that matches the search criteria. (Step 1000) As a specific example, the map 1210 in FIG. 12 illustrates the locations of a plurality of businesses that match the search criteria of “relaxing messages” and “San Francisco.”

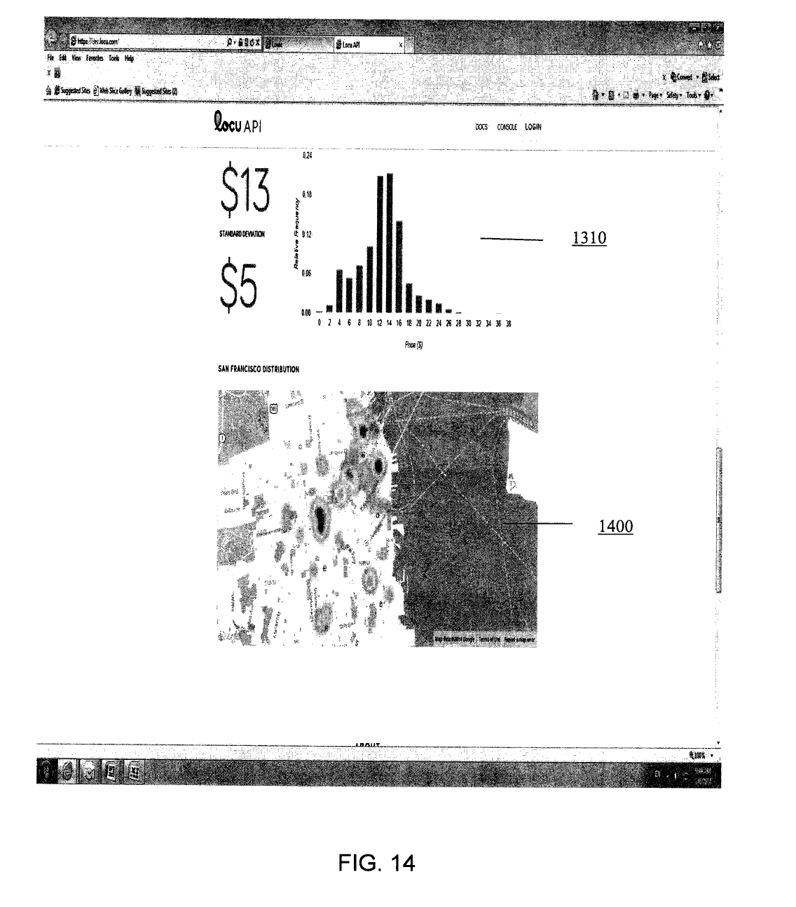

As another example, a heat map 1400 (showing business type density in a geographical region) is shown in FIG. 14. The heat map 1400 may be created based on a search criteria of “pizza” and “San Francisco” entered into one or more data input fields 1300. In addition to the heat map 1400, the one or more servers 130 may also calculate various statistics for businesses that match the search criteria. As an example, a bar graph 1310 may be displayed on a webpage, as illustrated in FIG. 13. The bar graph, as non-limiting examples, may display the mean, maximum, minimum, 95th percentile or any other statistic related to marketing information as desired.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) collecting, by a one or more hardware servers, a marketing information for a plurality of online businesses connected to a network;
b) receiving, by the one or more hardware servers, a first request from a user for a market analysis of a first online business connected to the network;
c) collecting, by the one or more hardware servers, a marketing information for the first online business;
d) determining, by the one or more hardware servers, a one or more online businesses in the plurality of online businesses that are similar to the first online business; and
e) comparing, by the one or more hardware servers, the marketing information for the first online business with a marketing information for the one or more online businesses.

2. The method of claim 1, further comprising the step of:
f) displaying, by the one or more hardware servers, to the user the marketing information for the first online business and a marketing information for the one or more online businesses.

3. The method of claim 1, further comprising the steps of:
f) recommending, by the one or more hardware servers, an action to the user based on comparing the marketing information for the first online business with the marketing information for the one or more online businesses.

4. The method of claim 1, further comprising the step of:
f) canonicalizing, by the one or more hardware servers, the marketing information for the plurality of online business and the marketing information for the first online business prior to step d).

5. The method of claim 1, wherein step a) further comprises scraping, by the one or more hardware servers, the plurality of online businesses for the marketing information for the plurality of online businesses.

6. The method of claim 1, wherein step c) further comprises scraping, by the one or more hardware servers, the first online business for the marketing information for the first online business.

7. The method of claim 1, further comprising the step of:
f) providing hosting services, by the one or more hardware servers, to the first online business.

8. The method of claim 1, further comprising the step of:
f) providing hosting services, by the one or more hardware servers, to the plurality of online businesses.

9. The method of claim 1, further comprising the steps of:
f) receiving, by the one or more hardware servers, a second request from the user to modify a website of the first online business;
g) modifying, by the one or more hardware servers, the website of the first online business according to the second request; and
h) publishing, by the one or more hardware servers, the modified website of the first online business.

10. A method, comprising the steps of:
a) scraping, by a one or more hardware servers, a marketing information for a plurality of online businesses connected to a network;
b) receiving, by the one or more hardware servers, a first request from a user for a market analysis of a first online business connected to the network;
c) scraping, by the one or more hardware servers, a marketing information for the first online business;
d) determining, by the one or more hardware servers, a one or more online businesses in the plurality of online businesses that are similar to the first online business; and
e) comparing, by the one or more hardware servers, the marketing information for the first online business with a marketing information for the one or more online businesses.

11. The method of claim 10, further comprising the step of:
f) displaying, by the one or more hardware servers, to the user the marketing information for the first online business and a marketing information for the one or more online businesses.

12. The method of claim 10, further comprising the steps of:
f) recommending, by the one or more hardware servers, an action to the user based on comparing the marketing information for the first online business with the marketing information for the one or more online businesses.

13. The method of claim 10, further comprising the step of:
f) canonicalizing, by the one or more hardware servers, the marketing information for the plurality of online business and the marketing information for the first online business prior to step e).

14. The method of claim 10, further comprising the step of:
f) providing hosting services, by the one or more hardware servers, to the first online business.

15. The method of claim 10, further comprising the step of:
f) providing hosting services, by the one or more hardware servers, to the plurality of online businesses.

16. The method of claim 10, further comprising the steps of:
f) receiving, by the one or more hardware servers, a second request from the user to modify a website of the first online business;
g) modifying, by the one or more hardware servers, the website of the first online business according to the second request; and
h) publishing, by the one or more hardware servers, the modified website of the first online business to the network.

17. A method, comprising the steps of:
a) hosting, by a one or more hardware servers, a plurality of online businesses connected to a network;
b) collecting, by the one or more hardware servers, a marketing information for the plurality of online businesses;
c) hosting, by the one or more hardware servers, a first online business connected to the network;
d) receiving, by the one or more hardware servers, a first request from a user for a market analysis of the first online business;
e) collecting, by the one or more hardware servers, a marketing information for the first online business;
f) determining, by the one or more hardware servers, a one or more online businesses in the plurality of online businesses that are similar to the first online business; and
g) comparing, by the one or more hardware servers, the marketing information for the first online business with a marketing information for the one or more online businesses.

18. The method of claim 17, further comprising the step of:
h) displaying, by the one or more hardware servers, to the user the marketing information for the first online business and a marketing information for the one or more online businesses.

19. The method of claim 17, further comprising the steps of:
h) recommending, by the one or more hardware servers, an action to the user based on comparing the marketing information for the first online business with the marketing information for the one or more online businesses.

20. The method of claim 17, further comprising the step of:
h) canonicalizing, by the one or more hardware servers, the marketing information for the plurality of online business and the marketing information for the first online business prior to step g).

21. The method of claim 17, wherein step b) further comprises analyzing, by the one or more hardware servers, a first website data of the plurality of online businesses for the marketing information for the plurality of online businesses.

22. The method of claim 17, wherein step e) further comprises analyzing, by the one or more hardware servers, a second website data of the first online business for the marketing information for the first online business.

23. The method of claim 17, further comprising the steps of:
h) receiving, by the one or more hardware servers, a second request from the user to modify a website of the first online business;
i) modifying, by the one or more hardware servers, the website of the first online business according to the second request; and
j) publishing, by the one or more hardware servers, the modified website of the first online business.

24. A method, comprising the steps of:
a) collecting, by a one or more hardware servers, a marketing information for a plurality of online businesses connected to a network;
b) storing the marketing information in a database;
c) receiving, by the one or more hardware servers, a search criteria from a requester; and
d) transmitting, by the one or more hardware servers, over an API to the requester only the marketing information that matches the search criteria.

25. A method, comprising the steps of:
a) collecting, by a one or more hardware servers, a marketing information for a plurality of online businesses connected to a network;
b) storing the marketing information in a database;
c) receiving, by the one or more hardware servers, a search criteria from a requester; and
d) displaying, by the one or more hardware servers, to the requester on a map on a webpage, only the marketing information that matches the search criteria.
